(19) United States
(12) Patent Application Publication
(10) Pub. No.: US 2025/0214029 A1
(43) Pub. Date: Jul. 3, 2025

(54) CARBON DIOXIDE CAPTURE MODULE

(71) Applicant: DAISHINKU CORPORATION, Kakogawa-shi, Hyogo (JP)

(72) Inventor: Manabu MARUMOTO, Kakogawa-shi (JP)

(73) Assignee: DAISHINKU CORPORATION, Kakogawa-shi, Hyogo (JP)

(21) Appl. No.: 18/855,639

(22) PCT Filed: Apr. 7, 2023
(86) PCT No.: PCT/JP2023/014355

§ 371 Date: Oct. 10, 2024

(30) Foreign Application Priority Data
Apr. 15, 2022 (JP) 2022-067638

(51) Int. Cl. B01D 53/14; B01D 39/20; B01J 20/16

(52) U.S. Cl. CPC B01D 53/1493; B01D 39/2027; B01D 53/1475; B01J 20/165; B01D 2252/204; B01D 2257/504

(57) ABSTRACT

A carbon dioxide capture module according to one or more embodiments may include: an absorber containing an amine-based absorbent capable of absorbing carbon dioxide; and a filter allowing air to pass through and preventing permeation of the amine-based absorbent. The filter is located between the amine-based absorbent and ambient air of the carbon dioxide capture module.

### TECHNICAL FIELD

The present invention relates to a carbon dioxide capture module that captures carbon dioxide in the air.

### BACKGROUND ART

Recently, there have been developments in technology for capturing and effectively using carbon dioxide as a typical global warming gas. In particular, thermal power plants, steel plants, chemical plants and the like, which emit large quantities of carbon dioxide, are strongly required to reduce emission of carbon dioxide.

As a carbon dioxide capture technology that is actually used, a chemical absorption method is known, in which amine solution is used to absorb carbon dioxide (see, for example, Patent Document 1).

### PRIOR ART DOCUMENT

### Patent Document

Patent Document 1: JP 2017-104775 A

### SUMMARY OF THE INVENTION

### Problem to Be Solved by the Invention

From the viewpoint of reduction of the global warming gas, it is desirable to collect carbon dioxide not only in the above thermal power plants and the steel plants, but also in ordinary households.

However, the chemical absorption method used in the above steel plants and the like requires large scale equipment. In addition, it is necessary to use strong alkaline amine in this method, which may cause health damage. Thus, the above method cannot be used to capture carbon dioxide in living spaces and the like of the ordinary households.

The present invention was made in consideration of the above circumstances, an object of which is to provide a carbon dioxide capture module having a simple structure to capture carbon dioxide, and thus capable of being used in living spaces in ordinary households.

### Means for Solving the Problem

In order to achieve the above object, the present invention has a configuration described below.

(1) A carbon dioxide capture module of the present invention captures carbon dioxide contained in the air. The carbon dioxide capture module includes: an absorber containing an amine-based absorbent capable of absorbing the carbon dioxide; and at least one filter allowing the air to pass through and preventing permeation of the amine-based absorbent. The at least one filter is located between the absorber and ambient air of the carbon dioxide capture module.

With the carbon dioxide capture module of the present invention, it is possible to absorb the carbon dioxide contained in the ambient air that has passed through the filter located between the absorber containing the amine-based absorbent and the ambient air of the carbon dioxide capture module, using the amine-based absorbent of the absorber. It is furthermore possible to prevent leakage of the amine-based absorbent toward the outside of the carbon dioxide capture module by blocking permeation of the amine-based absorbent using the filter.

In this way, it is possible to realize the carbon dioxide capture module having a simple structure to prevent the leakage of the amine-based absorbent. Thus, it is possible to easily capture a small amount of carbon dioxide contained in the air in a living space or the like of an ordinary household.

(2) In a preferable aspect of the present invention, the amine-based absorbent is a liquid amine-based absorbent or a gel amine-based absorbent.

In this aspect, when the amine-based absorbent is a liquid amine-based absorbent (i.e. when it is in the liquid state), it has a high fluidity. Thus, a reacted amine compound that has absorbed carbon dioxide and an un-reacting amine compound that has not yet absorbed carbon dioxide are likely to be evenly mixed. Also, it is possible to prevent reduction in capture of the carbon dioxide that has passed through the filter due to the reacted amine compound unevenly distributed on the side of the filter.

On the other hand, when the amine-based absorbent is a gel amine-based absorbent that has a low fluidity compared to the fluidity of the liquid amine-based absorbent, it is not likely to leak outside, and thus has excellent portability.

(3) In an aspect of the present invention, the carbon dioxide capture module is formed by: housing the absorber in an inside of the at least one filter having a hollow cylindrical shape; and sealing both end parts of the at least one filter. The carbon dioxide capture module has a substantially cylindrical shape as an external shape.

In this aspect, the absorber containing the amine-based absorbent can be made to have a cylindrical shape that is housed inside the filter having a hollow cylindrical shape. Thus, it is possible to increase the volume of the amine-based absorbent of the absorber compared to the case where the absorber is made to have, for example, a plate shape. As a result, it is possible to increase absorbed amount of the carbon dioxide.

(4) In another aspect of the present invention, the absorber and the at least one filter each have a plate shape. The absorber and the at least one filter are arranged facing each other, and the at least one filter is provided on a side facing the ambient air.

In this aspect, the rectangular plate-shaped absorber and the rectangular plate-shaped filter can face each other to be closely attached such that the filter is on the side facing the ambient air. In this way, it is possible to realize a thin carbon dioxide capture module having a simple structure.

(5) Furthermore, in another aspect of the present invention, the at least one filter is made by forming an LTA-type zeolite film on a main surface of a porous substrate, and the LTA-type zeolite film faces the absorber.

In this aspect, in the porous substrate of the filter located between the absorber and the ambient air, one main surface on which the LTA-type zeolite film is formed is an inner surface facing the absorber, while the other main surface on which no zeolite film is formed is an outer surface facing the ambient air. Therefore, the porous substrate covers and protects the inner zeolite film, which can prevent damage of the zeolite film of the filter.

(6) In one aspect of the present invention, a diameter of empty holes of LTA-type zeolite constituting the LTA-type zeolite film is smaller than a molecular diameter of amine constituting the amine-based absorbent.

In this aspect, the diameter of the empty holes of the LTA-type zeolite constituting the LTA-type zeolite film of the filter is smaller than the molecular diameter of the amine constituting the amine-based absorbent of the absorber. Thus, it is not possible for the amine constituting the amine-based absorbent of the absorber to permeate the filter facing the ambient air. Thus, it is possible to prevent leakage of the amine toward the outside of the carbon dioxide capture module.

(7) In another aspect of the present invention, the at least one filter includes two filters. The two filters each having the plate shape are located so as to face respective surfaces of the absorber having the plate shape. The carbon dioxide capture module further includes a sealing part that bonds a peripheral end part of the absorber to respective peripheral end parts of the two filters and that prevents the absorber from making contact with the ambient air except through the two filters.

In this aspect, the plate-shaped absorber is interposed between the two plate-shaped filters facing each other so that the peripheral end part of the absorber is bonded to the peripheral end parts of the filters. Thus, it is possible to seal the absorber by the sealing part such that the absorber does not make contact with the ambient air except through the filters. In this way, it is possible to realize the carbon dioxide capture module having a simple structure of the plate-shaped absorber sandwiched by the two plate-shaped filters so as to bond their peripheral end parts while preventing leakage of the amine-based absorbent toward the outside.

(8) Furthermore in another aspect of the present invention, the sealing part is made of a resin having a corrosion resistance against the amine-based absorbent.

In this aspect, it is possible to stably prevent the leakage of the amine-based absorbent outside the carbon dioxide capture module by the sealing part having a corrosion resistance against the amine-based absorbent of the absorber. Also, since the sealing part that covers the peripheral end parts of the absorber and the filters is made of a resin, it is possible to absorb the impact from the outside by the sealing part covering the peripheral end parts.

### Effects of the Invention

With the present invention, it is possible to absorb the carbon dioxide contained in the ambient air that has passed through the filter located between the absorber containing the amine-based absorbent and the ambient air of the carbon dioxide capture module, using the amine-based absorbent of the absorber. It is furthermore possible to prevent leakage of the amine-based absorbent toward the outside of the carbon dioxide capture module by blocking permeation of the amine-based absorbent using the filter.

In this way, it is possible to realize the carbon dioxide capture module having a simple structure to prevent the leakage of the amine-based absorbent. Thus, it is possible to easily capture a small amount of carbon dioxide contained in the air in a living space or the like of an ordinary household.

### BRIEF DESCRIPTION OF THE DRAWINGS

FIG. 1 is a schematic perspective view illustrating a carbon dioxide capture module according to an embodiment of the present invention.

FIG. 2 is a longitudinal cross-sectional view of FIG. 1.

FIG. 3 is an exploded perspective view illustrating main parts of FIG. 1.

FIG. 4 is a schematic view for explaining operations of the carbon dioxide capture module of FIG. 1.

FIG. 5 is a schematic perspective view according to another embodiment of the present invention, which corresponds to FIG. 1.

FIG. 6 is a schematic perspective view according to another embodiment of the present invention.

FIG. 7 is a longitudinal cross-sectional view of FIG. 6.

FIG. 8 is a schematic perspective view according to another embodiment of the present invention.

FIG. 9 is a longitudinal cross-sectional view of FIG. 8.

FIG. 10 is a schematic perspective view according to another embodiment of the present invention.

FIG. 11 is a longitudinal cross-sectional view of FIG. 10.

FIG. 12 is a schematic perspective view according to another embodiment of the present invention.

FIG. 13 is a longitudinal cross-sectional view of FIG. 12.

FIG. 14 is a schematic perspective view illustrating a carbon dioxide capture module structure according to another embodiment of the present invention.

FIG. 15 is a longitudinal cross-sectional view of the carbon dioxide capture module structure.

FIG. 16 is a longitudinal cross-sectional view of a carbon dioxide capture module using the structure of FIG. 14.

FIG. 17 is a longitudinal cross-sectional view according to another embodiment of the present invention.

FIG. 18 is a longitudinal cross-sectional view according to another embodiment of the present invention.

### MODE FOR CARRYING OUT THE INVENTION

Hereinafter, the embodiments of the present invention will be described in detail with reference to the drawings.

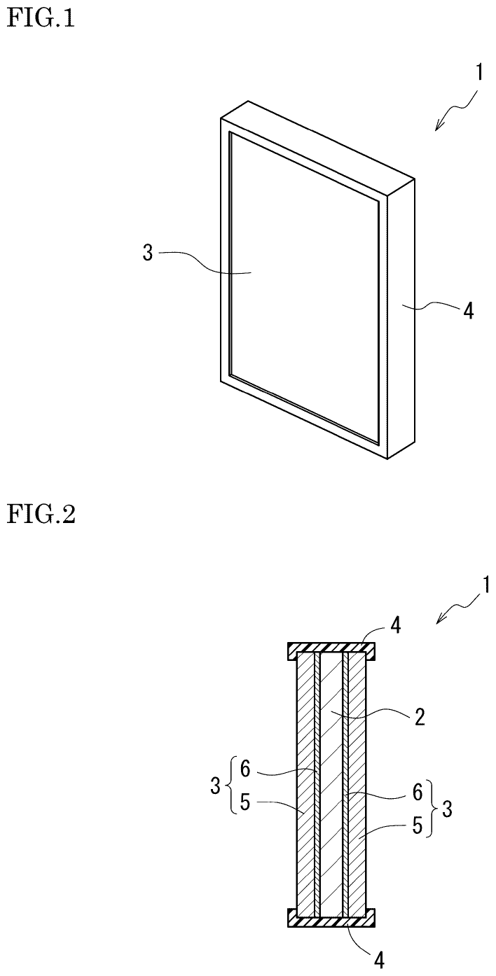

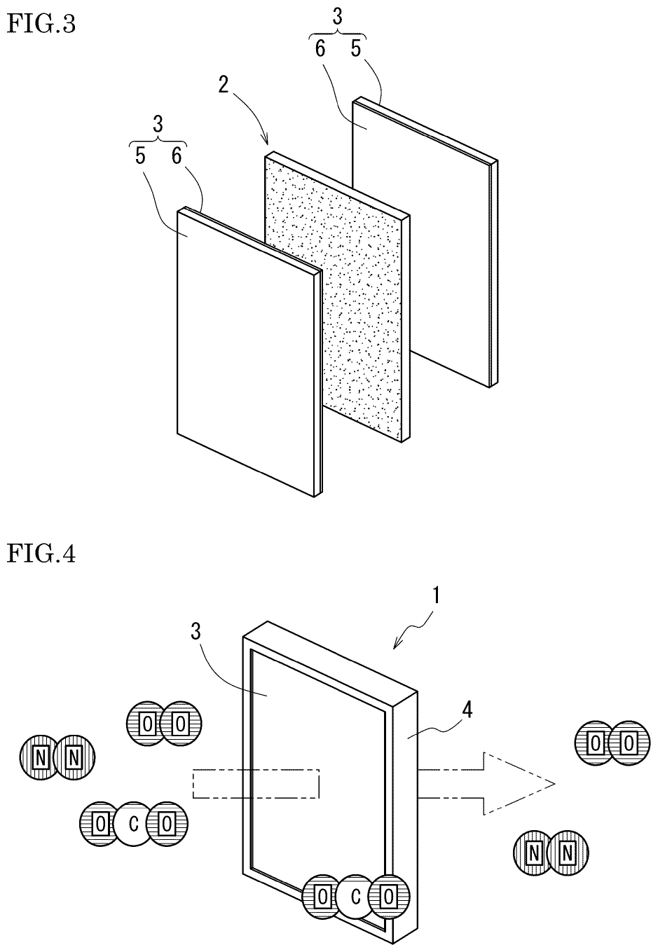

FIG. 1 is a schematic perspective view illustrating a carbon dioxide capture module 1 according to an embodiment of the present invention. FIG. 2 is a longitudinal cross-sectional view thereof. FIG. 3 is an exploded perspective view illustrating main parts thereof.

The carbon dioxide capture module 1 according to this embodiment is a module to capture a small amount of carbon dioxide contained in the ambient air, which is installed in a living space such as an indoor of an ordinary household.

This carbon dioxide capture module 1 includes: a rectangular plate-shaped absorber 2 containing an amine-based absorbent to capture carbon dioxide; and two rectangular plate-shaped filters 3 and 3 respectively closely attached to both surfaces of the absorber 2 so as to be opposed to each other.

The absorber 2 and the two filters 3 have the same rectangle size. The absorber 2 is sandwiched between the two filters 3 such that they are respectively closely attached to the absorber 2. Thus, the rectangular-shaped peripheral end parts thereof are integrally bonded and sealed by a sealing part 4 as a frame.

The absorber 2 has an amine-based absorbent that absorbs a small amount of carbon dioxide contained in the air. In this embodiment, the absorber 2 is constituted of a substrate made of a porous material that is impregnated with the liquid amine-based absorbent.

Examples of the amine-based absorbent that absorbs the carbon dioxide include: monoethanolamine; diethanolamine; triethanolamine; 2-amino-2-methyl-1-propanol; 2-(isopropylamino) ethanol; 2-(methylamino) ethanol; 2-(ethylamino) ethanol; N-methyldiethanolamine; ethylenediamine; hexamethylenediamine; diethylenetriamine; piperazine; o-xylenediamine; m-xylenediamine; and p-xylenediamine. Also, mixtures thereof may be used. Furthermore, these kinds of amine may be mixed into liquid such as ethylene glycol having a high boiling point and also having a molecular diameter of 4 Å or more that does not pass through the filter 3. When the amine-based absorbent as a mixture is used, the concentration of the liquid amine-based absorbent is preferably 30% or more.

Also, as the amine-based absorbent, it is possible to use polymeric amine having a number average molecular weight of 500 or more, or to use polymer of amine monomer with dicarboxylic acid monomer, whose number average molecular weight is 500 or more.

The above polymeric amine and polymer with the number average molecular weight of 500 or more are liquid or solid having almost no volatility. Even if they volatilize, the volatilization amount is extremely small, which does not affect the human body.

The polymeric amine as described above does not volatilize, unlike ethanolamine as the low molecular weight amine. Thus, the filter 3 is not required to prevent permeation of the volatilized amine-based absorbent. Therefore, the performance of preventing permeation of gas of the filter 3 may be lower than that of the filter capable of preventing permeation of the volatilized amine-based absorbent, which means that the air is likely to pass through the filter 3.

It is preferable to use, as the polymeric amine, polyethyleneimine having a number average molecular weight in the range of 10,000 to 100,000. The polyethyleneimine may be branched polyethyleneimine as liquid, or also may be linear polyethyleneimine as solid.

When the number average molecular weight of the liquid polyethyleneimine exceeds 100,000, such liquid polyethyleneimine is not handleable because of too high viscosity. Thus, by setting the maximum number average molecular weight of the polyethyleneimine to 100,000, it is possible to reduce degradation of handleability.

In this embodiment, monoethanolamine is used as the liquid amine-based absorbent.

As the substrate made of a porous material that is impregnated with the liquid amine-based absorbent, it is possible to use, for example: activated carbon; a porous ceramic substrate such as mesoporous silica, zeolite, porous alumina, and mullite; and a porous resin substrate.

In this embodiment, an alumina substrate is, for example, used, as the substrate made of a porous material.

The shape of the porous material is not limited to a plate. The porous material may have a cylindrical shape or a hollow cylindrical shape as described later.

Impregnation of the porous substrate with the liquid amine-based absorbent is performed by the steps below.

The liquid amine-based absorbent is mixed with a solvent. The porous substrate is immersed in the mixture for a predetermined period of time so that outer surfaces of the porous substrate and inner surfaces of fine pores inside the porous substrate are impregnated with the liquid amine-based absorbent. After that, only the solvent is volatilized by heating and decompression. Thus, the liquid amine-based absorbent is adhered to the outer surfaces of the porous substrate and the inner surfaces of the fine pores inside the porous substrate.

As described above, the absorber 2 is constituted of an impregnated body made by impregnation of the porous substrate with the amine-based absorbent. Thus, the total area increases, where the carbon dioxide can make contact with the amine-based absorbent adhered to the inner surfaces of the fine pores inside the porous substrate. In this way, a large amount of carbon dioxide is absorbed by the amine-based absorbent of the absorber 2, which improves collection rate of the carbon dioxide.

Each of the filters 3 is made by forming an LTA-type zeolite film 6 on one main surface of the rectangular plate-shaped porous substrate 5.

The LTA-type zeolite film 6 of the filter 3 is a porous film having fine empty holes (pores) derived from the crystal structure. By molecular sieve function, the LTA-type zeolite film 6 allows the molecules having a diameter smaller than that of the empty holes to pass through, while prevents the molecules having a diameter larger than that of the empty holes from passing through.

The LTA-type zeolite film 6 in this embodiment is made of Na-LTA-type zeolite containing Na ion in its framework. Since the diameter of the empty holes of this zeolite is about 4 Å, the air having a smaller molecular diameter can pass through this film 6. However, the amine constituting the amine-based absorbent is prevented.

As the LTA-type zeolite film 6, it is preferable to use the above-described Na-LTA-type zeolite when the amine-based absorbent of the absorber 2 is made of linear amine such as monoethanolamine having a relatively small molecular diameter. When the amine-based absorbent is, for example, made of 2-amino-2-methyl-1-propanol having a branched structure or xylenediamine having a phenyl group, both of which have a relatively large molecular diameter, then it is possible to use Ca-LTA-type zeolite.

As the porous substrate 5 on one main surface of which the LTA-type zeolite film 6 is formed, it is possible to use, for example, a ceramic substrate such as an alumina substrate made of aluminum oxide, or a porous resin substrate.

Formation of the Na-LTA-type zeolite film 6 on the porous substrate 5 can be, for example, performed by the steps below.

First, the porous substrate is immersed in seed crystal slurry made by dispersing zeolite powders in the water. After taking out of the slurry, the porous substrate is heated and dried. Thus, the seed crystals are applied onto the porous substrate.

Next, reaction solution is prepared by mixing a silicon (Si) supply source such as sodium silicate, an aluminum (Al) supply source such as sodium aluminate, sodium hydroxide, and ion exchange water.

The porous substrate, which is covered by a protection member except for the surface on which the film is to be formed, is put in this reaction liquid in a state in which the surface for forming the film faces down so as to be subjected to hydrothermal treatment at 100° C. for 6 hours. After the hydrothermal treatment, the porous substrate having the surface on which the zeolite film is formed is cleaned by ion exchange water, and dried at 120° C.

The zeolite film may be formed on the surface of the porous substrate, on which the film is to be formed, without hydrothermal treatment. When the zeolite is formed as a thin film, its mechanical strength is low and thus it is not applicable to practical use. However, by forming the film on the porous substrate 5, it is possible to stably maintain the LTA-type zeolite film 6.

The two filters 3 face each other such that the LTA-type zeolite film 6 formed on one main surface thereof faces the absorber 2.

As described above, the filter 3 is configured such that the LTA-type zeolite film 6 faces the inner absorber 2 while the porous substrate 5 faces the outside to make contact with the ambient air. Thus, the inner LTA-type zeolite film 6 is protected by the outer porous substrate 5 that serves as a cover. Therefore, it is possible to prevent damage of the inner LTA-type zeolite film 6.

The sealing part 4 is formed as a rectangular frame that covers the peripheral end parts of the absorber 2 and the two filters 3 respectively closely attached to the absorber 2 sandwiched therebetween.

The sealing part 4 prevents the absorber 2 from making contact with the ambient air except through the filters 3 and 3. That is, except for the sealing part 4, the filters 3 and 3 are located between the absorber 2 and the ambient air surrounding the carbon dioxide capture module 1. Therefore, the amine-based absorbent in the absorber 2 does not leak outside from the sealing part 4.

The sealing part 4 is preferably made of a corrosion resistant material, in particular an alkali resistant resin material. Preferable examples of the alkali resistant resin material include: polyethylene; polypropylene; nylon; polytetrafluoroethylene; ethylene tetrafluoroethylene; a phenolic resin; and an epoxy resin.

Alternatively, the sealing part 4 may be made of a metal material, i.e. a corrosion resistant metal material such as stainless. As the metal material, it is possible to use, apart from the stainless, iron, copper, titanium, chromium, and nickel depending on the kind of the amine-based absorbent. When using, as the base material, the metal material having the risk of corrosion by the amine-based absorbent, the surfaces of the base material may be covered with a film made of the corrosion resistant material such as a metal (for example, titanium, chromium, and nickel), and a resin (for example, polytetrafluoroethylene (PTFE)).

FIG. 4 is a schematic view for explaining operations of the carbon dioxide capture module 1 in this embodiment.

The air containing, for example, nitrogen (N₂), oxygen (O₂) and carbon dioxide (CO₂) flows toward one filter 3 of the carbon dioxide capture module 1, in the direction shown in the arrow as a virtual line. The air passes through the porous substrate 5 and permeates the LTA-type zeolite film 6, of the above filter 3, so as to reach the absorber 2. At this time, a small amount of carbon dioxide contained in the air is not absorbed by the LTA-type zeolite film 6 but permeates the LTA-type zeolite film 6.

The carbon dioxide (CO₂) contained in the air that permeates the LTA-type zeolite film 6 and reaches the absorber 2 is absorbed by the amine-based absorbent with which the porous substrate is impregnated, as the absorber 2. The air containing the components other than the carbon dioxide (CO₂) such as nitrogen (N₂) and oxygen (O₂) is not absorbed by the absorber 2 and permeates the LTA-type zeolite film 6 constructing the other filter 3. Then, this air passes through the porous substrate 5 so as to go outside the carbon dioxide capture module 1.

In this way, a small amount of carbon dioxide (CO₂) contained in the air that permeates the porous substrate 5 and the LTA-type zeolite film 6 of the filter 3 is absorbed and thus captured by the amine-based absorbent of the absorber 2. The carbon dioxide capture module in this embodiment may be installed in the environment where the air is likely to pass through. Also, it is possible to add a mechanism to forcibly flow the air using an air blower or the like. In this embodiment as described above, the air flows toward the carbon dioxide capture module 1 with the flow of the wind. However, even when there is no wind (in the windless state), it is still possible to capture a small amount of carbon dioxide contained in the air.

The liquid amine-based absorbent, with which the absorber 2 is impregnated, is made of amine having the molecular diameter larger than the diameter of the empty holes of zeolite constituting the LTA-type zeolite film 6 of the filter 3. Thus, the amine cannot permeate the LTA-type zeolite film 6 of the filter 3. In other words, the amine is confined in the absorber 2 by the two filters 3 and the sealing part 4. Thus, the toxic amine-based absorbent of the absorber 2 does not leak outside the carbon dioxide capture module 1.

As described above, the carbon dioxide capture module 1 in this embodiment uses a chemical absorption method for causing the amine-based absorbent to absorb carbon dioxide contained in the air while preventing leakage of the amine-based absorbent toward the outside of the carbon dioxide capture module 1.

Furthermore, the rectangular plate-shaped absorber 2 is interposed between the two rectangular plate-shaped filters 3, which is so-called sandwich structure. Then, the rectangular-shaped peripheral end parts of this sandwich structure are sealed by the sealing part 4. The carbon dioxide capture module 1 has such a simple structure. Thus, it is possible, for example, to capture a small amount of carbon dioxide in the air by installing or hanging the carbon dioxide capture module 1 in the living spaces such as the inside of an ordinary household and the inside of a vehicle.

The size of the carbon dioxide capture module 1 is not particularly limited, however, the size is preferably a portable size that can be easily carried in the indoor and the like where many people gather. Thus, the horizontal and vertical size of each of the rectangular plates may be, for example, the A-four size. Also, in order to easily carry the module 1, a handle or the like may be formed on an upper end surface of the frame-shaped sealing part 4. After a predetermined period has passed, the used carbon dioxide capture modules 1, which were installed in the living spaces of the respective households and caused the amine-based absorbent of the absorber 2 to absorb the carbon dioxide contained in the air, are collected in a plant or the like having a regeneration furnace. A number of used carbon dioxide capture modules 1 collected in the plant are heated in the regeneration furnace at about 120° C. so as to release carbon dioxide from the amine-based absorbent of the absorber 2. The carbon dioxide that is released from the amine-based absorbent permeates the LTA-type zeolite film 6 of the filter 3, thus is released outside the carbon dioxide capture module 1.

The carbon dioxide released from the carbon dioxide capture modules 1 is collected, and thus collected carbon dioxide can be adapted to other uses such as artificial photosynthesis that synthesizes chemical products using solar energy.

The recycled carbon dioxide capture module 1 by releasing the carbon dioxide from the amine-based absorbent of the absorber 2 are re-delivered to the respective households. In this way, the carbon dioxide capture modules 1 can be used for a long time by repeating the cycle of capturing the carbon dioxide, collecting the carbon dioxide, and recycling the module 1.

In the above-described embodiment, the carbon dioxide capture module 1 has a substantially rectangular parallelepiped shape made by: providing the two rectangular plate-shaped filters 3 and 3 on the respective surfaces of the rectangular plate-shaped absorber 2 such that the filters 3 and 3 are opposed to each other; and sealing the peripheral end parts thereof. However, the absorber 2 and the filters 3 are not necessarily required to have the rectangular plate-shape. They may have another shape.

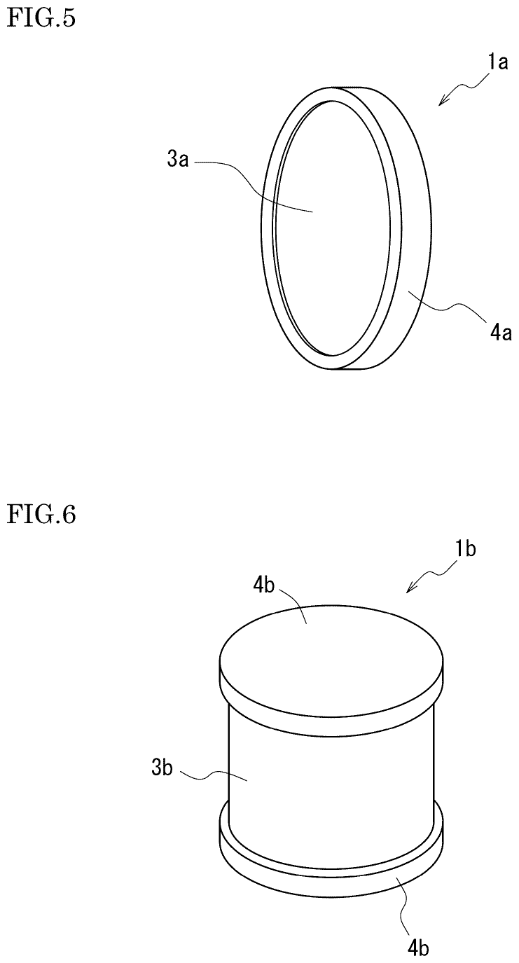

For example, as shown in the schematic perspective view of FIG. 5, which corresponds to FIG. 1 described above, a substantially disc-shaped carbon dioxide capture module la may be configured by providing two disc-shaped filters 3a on the respective surfaces of the disc-shaped absorber such that the filters 3a are opposed to each other; and sealing the peripheral end parts of the discs by a sealing part 4a.

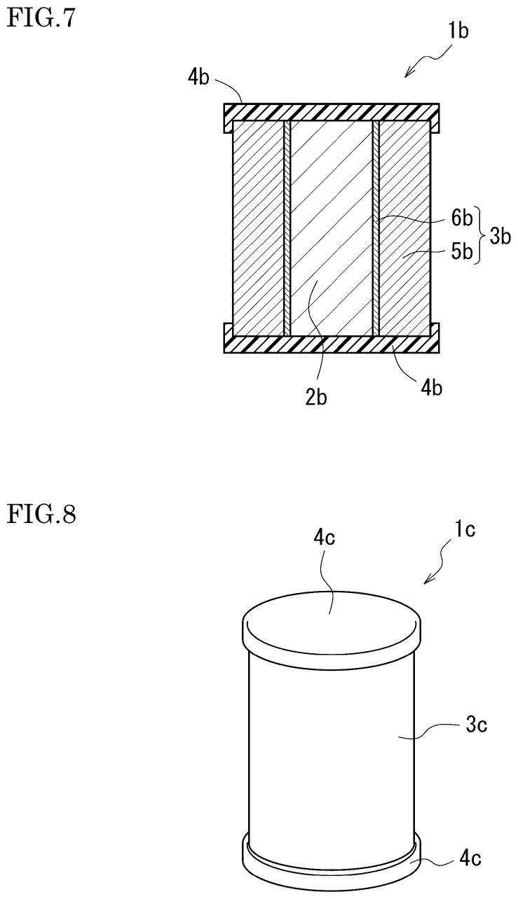

Also, as shown in the schematic perspective view of FIG. 6 and its longitudinal cross-sectional view of FIG. 7, a substantially cylindrical-shaped carbon dioxide capture module 1b may be used.

In this carbon dioxide capture module 1b, a cylindrical-shaped absorber 2b is housed in a hollow cylindrical-shaped filter 3b, and upper and lower end parts thereof are sealed respectively by sealing parts 4b. Except for the upper and lower sealing parts 4b, the carbon dioxide capture module 1b has a cylindrical shape as an external shape, that is, it generally has a substantially cylindrical shape. The cylindrical-shaped absorber 2b is constituted of a cylindrical-shaped porous base material that is impregnated with the liquid amine-based absorbent. The hollow cylindrical-shaped filter 3b is made by forming an LTA-type zeolite film 6b on an inner circumferential surface of a hollow cylindrical-shaped porous base material 5b.

In the above-described embodiment, the alumina substrate is the porous material impregnated with the liquid amine-based absorbent. However, in another embodiment of the present invention, the porous material impregnated with the liquid amine-based absorbent may be, for example, sponge made of polyurethane or a melamine resin.

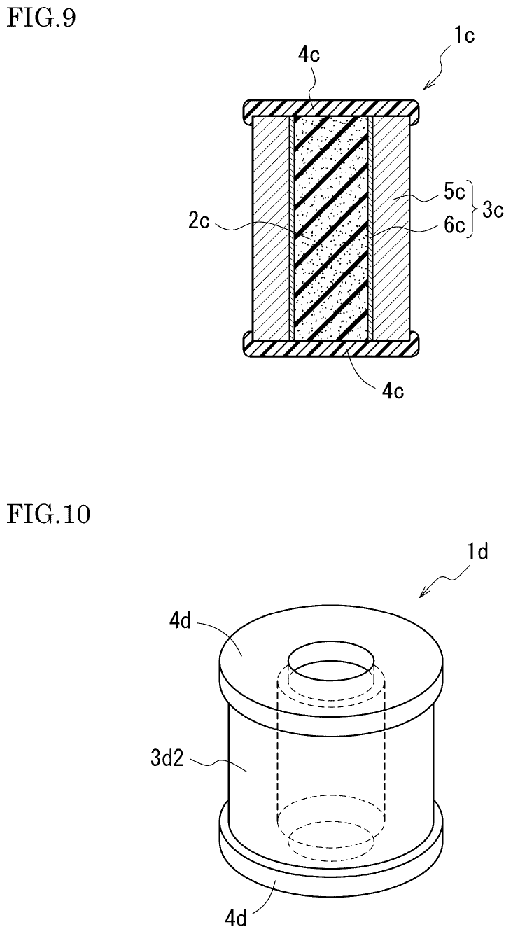

FIG. 8 is a schematic perspective view of the carbon dioxide capture module according to another embodiment of the present invention. FIG. 9 is a longitudinal cross-sectional view thereof.

In a carbon dioxide capture module 1c in this embodiment, the absorber 2c is sponge made of, for example, polyurethane or a melamine resin, which is impregnated with the liquid amine-based absorbent.

In this case, unlike the impregnation of the porous alumina substrate, it is sufficient to soak the sponge in the liquid amine-based absorbent and hold it.

Thus, in the case of the absorber 2c, it is possible to configure the impregnated body by simply soaking the sponge in the liquid amine-based absorbent. Therefore, the impregnated body is easily provided compared to the above-described embodiment in which the porous alumina substrate is immersed in the mixture of the liquid amine-based absorbent with the solvent and after that the solvent is volatilized by heating and decompression.

The cylindrical-shaped absorber 2c is housed in a hollow cylindrical-shaped filter 3c and upper and lower end parts thereof are sealed respectively by sealing parts 4c. The hollow cylindrical-shaped filter 3c is made by forming an LTA-type zeolite film 6c on an inner circumferential surface of a hollow cylindrical-shaped porous base material 5c.

Except for the upper and lower sealing parts 4c, the carbon dioxide capture module 1c of this embodiment has a cylindrical shape as an external shape, that is, it generally has a substantially cylindrical shape.

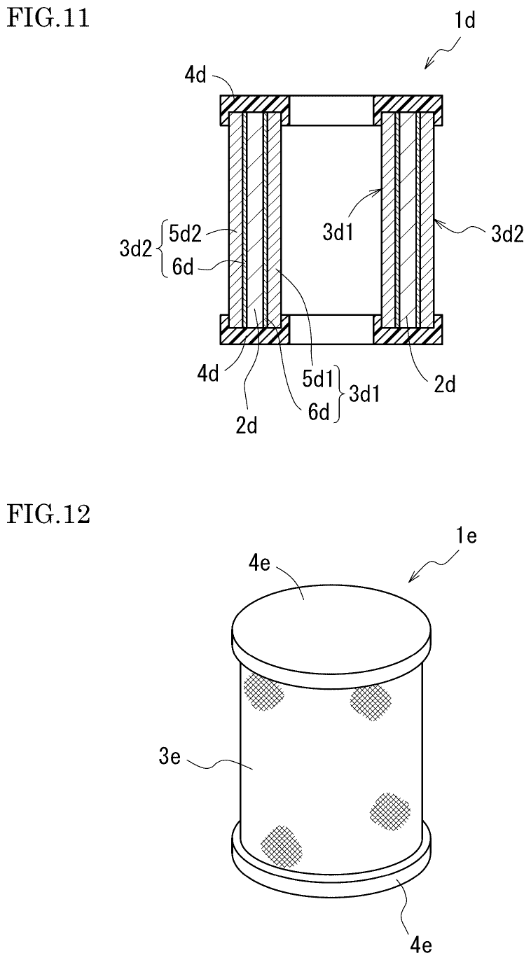

Also, as shown in the schematic perspective view of FIG. 10 and its longitudinal cross-sectional view of FIG. 11, a substantially hollow cylindrical-shaped (circular pipe-shaped) carbon dioxide capture module 1d may be used.

In this carbon dioxide capture module 1d, a hollow cylindrical-shaped absorber 2d is housed between a hollow cylindrical-shaped first filter 3d1 as an inner hollow cylinder and a hollow cylindrical-shaped second filter 3d2 as an outer hollow cylinder having a diameter larger than that of the first filter 3d1. In this state, upper and lower annular end parts are sealed respectively by sealing parts 4d.

The hollow cylindrical-shaped absorber 2d is constituted of a hollow cylindrical-shaped porous base material that is impregnated with the liquid amine-based absorbent. The first filter 3d1 as the inner hollow cylinder is made by forming an LTA-type zeolite film 6d on an outer circumferential surface of a hollow cylindrical-shaped porous base material 5d1. The second filter 3d2 as the outer hollow cylinder is made by forming an LTA-type zeolite film 6d on an inner circumferential surface of a hollow cylindrical-shaped porous base material 5d2.

In this embodiment, the ambient air can flow through the hollow cylindrical-shaped absorber 2d not only from the second filter 3d2 as the outer hollow cylinder but also from the first filter 3d1 as the inner hollow cylinder. In this way, it is possible to efficiently absorb carbon dioxide contained in the air.

The shape of the carbon dioxide capture module is not limited to the shapes described above. It may be another shape such as a spherical shape.

As the amine-based absorbent as described above, it is possible to use polymeric amine having a number average molecular weight of 500 or more. The above polymeric amine having the number average molecular weight of 500 or more (such as polyethyleneimine) has almost no volatility. Even if it volatilizes, the volatilization amount is extremely small, which does not affect the human body.

Thus, when the polymeric amine such as polyethyleneimine is used as the amine-based absorbent, it is not necessary to block leakage of the volatilized amine to the outside using the filter, unlike the case where the low molecular weight amine such as ethanolamine is used as the amine-based absorbent. It is only required to block the liquid amine-based absorbent. Therefore, it is not necessary to use a zeolite film having fine empty holes (pores) derived from the crystal structure, which is used to prevent permeation of the volatilized low molecular weight amine such as ethanolamine.

As described above, when the filter is not required to block permeation of the volatilized amine-based absorbent but required to only block the liquid amine-based absorbent, the filter may be made of the materials described below.

Specifically, as the materials of the filter, it is possible to use a film-like or sheet-like porous resin such as a polyolefin type porous film c a polytetrafluoroethylene (PTFE) porous film.

When a film-like or sheet-like porous resin is used, it is preferable to support the film-like or sheet-like porous resin and also to bond the film-like or sheet-like porous resin to such a support as a protector.

The air is likely to pass through the filter made of the porous resin compared to the filter made of the zeolite film.

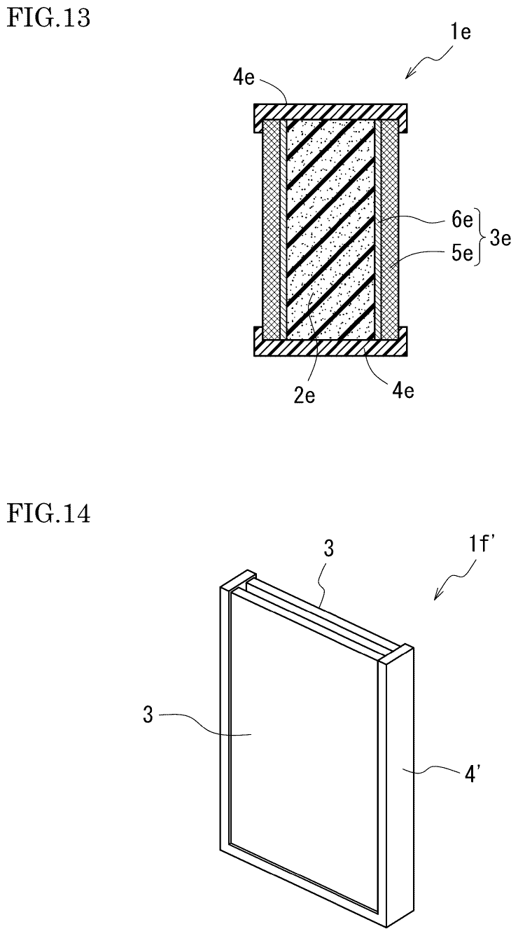

FIG. 12 is a schematic perspective view of a carbon dioxide capture module le according to another embodiment of the present invention. FIG. 13 is a longitudinal cross-sectional view thereof. The carbon dioxide capture module 1e of this embodiment has a substantially cylindrical shape as an external shape.

In this carbon dioxide capture module le, a cylindrical-shaped absorber 2e is housed in a hollow cylindrical-shaped filter 3e, and upper and lower end parts thereof are sealed respectively by sealing parts 4e.

The filter 3e is made by bonding a porous film 6e made of polytetrafluoroethylene (PTFE) to an inner circumferential surface of a hollow cylindrical-shaped support 5e made of metal mesh.

In this embodiment, the amine-based absorbent of the absorber 2e is polyethyleneimine. As the porous material to be impregnated with the polyethyleneimine, sponge made of, for example, polyurethane or a melamine resin is used.

That is, the absorber 2e is constituted of an impregnated body made by soaking the cylindrical-shaped sponge in the liquid polyethyleneimine.

The support 5e of the filter 3e does not prevent the permeability of the porous film 6e while stably supporting the porous film 6e. Furthermore, the support 5e protects the porous film 6e from damage.

The support 5e is simply required to have breathability, and thus can be made of a resin or a metal mesh material, or a glass material such as glass wool. It is also possible to use the porous material made of ceramic such as alumina (aluminum oxide) and mullite, or a resin such as epoxy, provided that it has the breathability for the air to pass through sufficiently.

In this embodiment, the porous film 6e of the filter 3e blocks the liquid while maintaining the breathability. Thus, a large amount of air passes through the filter 3e so that carbon dioxide is absorbed by the amine-based absorbent of the absorber 2e. Furthermore, since the polyethyleneimine as the liquid amine-based absorbent is blocked, it is possible to prevent leakage of the amine-based absorbent toward the outside of the carbon dioxide capture module 1e.

In the carbon dioxide capture modules 1 and 1a-1e in the above respective embodiments, the absorbers 2 and 2b-2e are each constituted of a base material made of a porous material, which is impregnated with the liquid amine-based absorbent. However, the liquid amine-based absorbent is not necessarily required to be used by soaking the porous base material into it. The liquid amine-based absorbent may be used in the liquid form.

As exemplarily shown in FIG. 14, which is a schematic perspective view illustrating the main parts, two rectangular plate-shaped filters 3 and 3 are provided so as to be opposed to each other with a certain space being interposed therebetween. The peripheral end parts except for an upper part are sealed by a sealing part 4′ so that only the upper part is opened. Thus, a carbon dioxide capture module structure 1f′ is formed in a container shape with the upper part being opened.

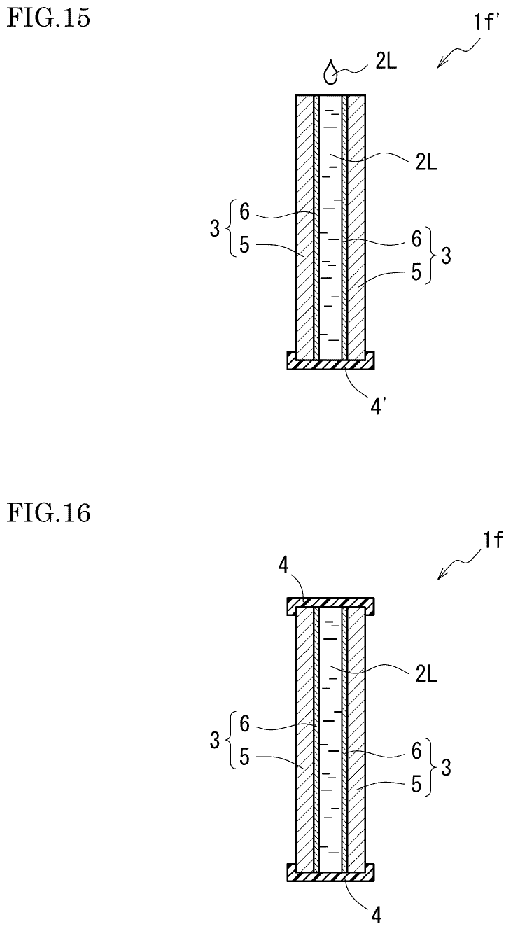

As shown in the longitudinal cross-sectional view of FIG. 15, a liquid amine-based absorbent 2L is injected into the carbon dioxide capture module structure 1f′. After that, the opening of the upper part is sealed so as to form the sealing part 4 that surrounds all the peripheral end parts. In this way, a carbon dioxide capture module 1f is obtained as shown in the longitudinal cross-sectional view of FIG. 16, in which the liquid amine-based absorbent 2L constituting the absorber is hermetically encapsulated.

This carbon dioxide capture module 1f shown in FIG. 16 corresponds to the carbon dioxide capture module 1 shown in FIG. 2, where the absorber 2 made of the porous substrate impregnated with the amine-based absorbent is replaced with the liquid amine-based absorbent 2L.

This liquid amine-based absorbent has a high fluidity, and thus, the reacted amine compound that has absorbed carbon dioxide and the un-reacting amine compound that has not yet absorbed carbon dioxide are likely to be evenly mixed. Thus, it is possible to prevent reduction in capture of the carbon dioxide that has passed through the filter 3 due to the reacted amine compound unevenly distributed on the side of the filter 3, which also leads to improvement of collection efficiency of the carbon dioxide. In addition, it is possible to further improve mixing of the reacted amine compound with the un-reacting amine compound by appropriately giving vibrations or the like to the carbon dioxide capture module 1f.

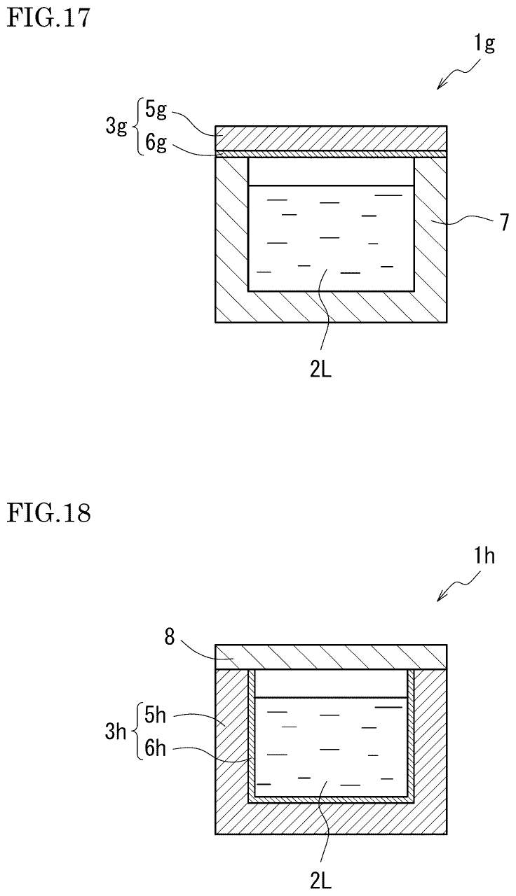

Alternatively, as shown in the longitudinal cross-sectional view of FIG. 17, the liquid amine-based absorbent 2L may be housed in a container body 7 having a recess part and an upper part that is opened. The opened upper part of the container body 7 that houses the liquid amine-based absorbent 2L is sealed by bonding to a filter 3g as a lid made of a porous substrate 5g including an LTA-type zeolite film 6g formed on an inner surface thereof. Thus, a carbon dioxide capture module 1g is formed.

The container body 7 is made of, for example, a resin or ceramic other than the porous substances. The absorber constituted of the liquid amine-based absorbent 2L is sealed such that it makes contact with the ambient air only through the filter 3g.

As shown in FIG. 17, the LTA-type zeolite film 6g may only face one surface (upper surface) of the liquid amine-based absorbent 2L constituting the absorber.

Furthermore, in another embodiment as shown in FIG. 18, a container body of a carbon dioxide capture module 1h may be formed by a filter 3h constituted of: a container-shaped porous base material 5h having a recess part and an upper part that is opened; and an LTA-type zeolite film 6h formed on an all the inner surfaces of the porous base material 5h. The opened upper part of the filter 3h may be sealed by a plate-like lid 8 made of, for example, a resin or ceramic other than the porous substances.

The LTA-type zeolite film 6h is not particularly required to be formed on all the inner surfaces of the container-shaped porous base material 5h. It may be formed on a part of the inner surfaces, for example, on an inner bottom surface or an inner peripheral surface.

In place of the lid 8, the filter 3g shown in FIG. 17 may be used to seal the opening of the container-shaped filter 3h.

In FIGS. 17 and 18, the amount of the liquid amine-based absorbent 2L that is housed in the container body is an amount not making contact with the filter 3g and the lid 8 that seal the opening of the upper part of the container body. However, the housed liquid amine-based absorbent 2L may have an amount that makes contact with the filter 3g and the lid 8.

As the amine-based absorbent, a gel amine-based absorbent may be used in place of the liquid amine-based absorbent.

In the respective embodiments as described above, the LTA-type zeolite film and the porous film are provided on the inner side of the carbon dioxide capture module. However, they may be provided on the outer side of the carbon dioxide capture module, or on both the inner side and the outer side thereof.

In the respective embodiments as described above, the zeolite film is the LTA-type zeolite film. However, it is not particularly limited to the LTA-type zeolite film. Another type of zeolite such as a CHA type may be used.

### DESCRIPTION OF THE REFERENCE NUMERALS

1, 1a-1h Carbon dioxide capture module
2, 2b-2e Absorber
2L Liquid amine-based absorbent
3, 3a-3c, 3e, 3g, 3h Filter
3d1, 3d2 First filter, second filter
4, 4a-4e Sealing part
5, 5g Porous substrate
6, 6b-6d, 6g, 6h LTA-type zeolite film

1. A carbon dioxide capture module capturing carbon dioxide contained in air, comprising:
an absorber containing an amine-based absorbent capable of absorbing the carbon dioxide; and
at least one filter allowing the air to pass through and preventing permeation of the amine-based absorbent, wherein
the at least one filter is located between the absorber and ambient air of the carbon dioxide capture module.

2. The carbon dioxide capture module according to claim 1, wherein
the amine-based absorbent is a liquid amine-based absorbent or a gel amine-based absorbent.

3. The carbon dioxide capture module according to claim 1, wherein
the carbon dioxide capture module is formed by: housing the absorber in an inside of the at least one filter having a hollow cylindrical shape; and sealing both end parts of the at least one filter, and
the carbon dioxide capture module has a substantially cylindrical shape as an external shape.

4. The carbon dioxide capture module according to claim 1, wherein
the absorber and the at least one filter each have a plate shape,
the absorber and the at least one filter are arranged facing each other, and
the at least one filter is provided on a side facing the ambient air.

5. The carbon dioxide capture module according to claim 4, wherein
the at least one filter is made by forming an LTA-type zeolite film on a main surface of a porous substrate, and
the LTA-type zeolite film faces the absorber.

6. The carbon dioxide capture module according to claim 5, wherein
a diameter of empty holes of LTA-type zeolite constituting the LTA-type zeolite film is smaller than a molecular diameter of amine constituting the amine-based absorbent.

7. The carbon dioxide capture module according to claim 4, wherein
the at least one filter comprises two filters,
the two filters each having the plate shape are located so as to face respective surfaces of the absorber having the plate shape, and
the carbon dioxide capture module further includes a sealing part that bonds a peripheral end part of the absorber to respective peripheral end parts of the two filters and that prevents the absorber from making contact with the ambient air except through the two filters.

8. The carbon dioxide capture module according to claim 7, wherein
the sealing part is made of a resin having a corrosion resistance against the amine-based absorbent.
